(19) United States
(12) Patent Application Publication
(10) Pub. No.: US 2019/0179957 A1
(43) Pub. Date: Jun. 13, 2019

(54) MONITORING UPDATES TO A DOCUMENT BASED ON CONTEXTUAL DATA

(71) Applicant: Promontory Financial Group LLC, Washington, DC (US)

(72) Inventors: Joshua N Andrews, Centennial, CO (US); Kelly A Argyros, Fairfax, VA (US); Thomas C Wisehart, JR., Centennial, CO (US)

(21) Appl. No.: 15/838,481

(22) Filed: Dec. 12, 2017

(51) Int. Cl. G06F 17/30; G06F 17/27; G06F 11/34

(52) U.S. Cl. CPC G06F 17/30722; G06F 17/30011; G06F 11/3466; G06F 17/2705

(57) ABSTRACT

A method, computer system, and computer program product for monitoring content updates to a document based on contextual data. A content update within an existing document stored in a database is detected. Contextual data from the content update is extracted, the contextual data including temporal delay between upload time of a first version of the content update and upload time of a last version of the content update. Relevance score of the content update is computed based on the contextual data. An alert is issued in response to determining that the relevance score of the content update exceeds a first threshold value.

### TECHNICAL FIELD

The present invention relates generally to a method, system, and computer program product for detecting updates in unstructured documents. More particularly, the present invention relates to a method, system, and computer program product for monitoring updates in unstructured documents based on contextual data.

### BACKGROUND

Documents and other types of data are becoming available at the internet at a rapid pace. Indeed, the trend of electronically storing data and determining actions based on such stored data has become the norm for several organizations as such reduces costs and increases workflow efficiency. The sources that generate these documents and other types of data can vary. For example, documents and other types of data can be generated internally within an organization or alternatively can be retrieved from third party data sources. In addition, existing data can be updated or deleted in which the changes can be reflected upon such updates. In the case of data being updated by third party data sources, such sources may notify the subscribers or the users of the data that it has been updated. In some cases, the updates may be pushed and installed into the organizations' systems automatically, typically upon pre-authorizations from the organizations.

A parser is a software component that can receive unstructured documents and construct a data structure to provide a structural representation of the input which can be used by data processing systems for further consumption. The data structures may include a parse tree, abstract syntax tree or other hierarchical structure, which may be configured based on the needs of the processing system. Parsing operations may involve pre-processing or post-processing steps that may stage the data for better accuracy. For instance, the parser is often preceded by a separate lexical analyser, which creates tokens from the sequence of input characters; alternatively, these can be combined in scannerless parsing. Parsers may be programmed manually or may be automatically or semi-automatically generated by a parser generator system.

### SUMMARY OF THE INVENTION

The illustrative embodiments provide a method, system, and computer program product. An aspect of the present invention detects a content update within an existing document stored in a database. The aspect of the present invention extracts contextual data from the content update, the contextual data including temporal delay between upload time of a first version of the content update and upload time of a last version of the content update. The aspect of the present invention computes relevance score of the content update based on the contextual data. The aspect of the present invention issues an alert in response to determining that the relevance score of the content update exceeds a first threshold value.

An aspect of the present invention includes a computer program product. The computer program product includes one or more computer-readable storage devices, and program instructions stored on at least one of the one or more storage devices.

An aspect of the present invention includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example system for monitoring updates to a document based on contextual data in accordance with an illustrative embodiment;

FIG. 4 depicts a block diagram of an example implementation of monitoring updates to a document based on contextual data in accordance with an illustrative embodiment; and

FIG. 5 depicts a flowchart of an example process for monitoring updates to a document based on contextual data in accordance with an illustrative embodiment.

### DETAILED DESCRIPTION OF THE EMBODIMENTS

Illustrative embodiments recognize that several entities operate in an environment where regulatory activities are prevalent. Regulations issued by different categories of entities such as Consumer Financial Protection Bureau and Office of Foreign Asset Control are increasing exponentially on a daily basis, and most of these rules and regulations by the entities impose compliance obligations on the entities when they conduct their business operations. Illustrative embodiments recognize that entities in some industries face numerous compliance obligations at the entire entity level, whereas other entities need to address compliance obligations only when they conduct a specific subset of their business activities. Illustrative embodiments further recognize that some entities may provide a set of products and services that may be regulated more than the entities' other products and services. Illustrative embodiments recognize that an entity's failure to implement or follow relevant compliance obligations may lead to negative consequences, ranging from sanctions to being barred from operating in a business space altogether.

Illustrative embodiments recognize that the entities have a difficult time keeping up the ever-increasing number of compliance obligations. In addition to newly announced regulations which trigger additional compliance obligations, illustrative embodiments also recognize that existing regulations may be amended by adding or revising certain language, which may likely lead to additional compliance obligations. Illustrative embodiments also recognize that existing regulations may be removed in part or altogether, which may result in certain compliance obligations to be outdated.

With an increasing number of applicable compliance obligations, illustrative embodiments recognize that entities have leveraged software systems to monitor, select, and certify their level of compliance with the obligations. For example, a database can store a compilation of compliance obligations which are assigned to a set of business categories and provide summaries of the obligations along with the regulations to which the obligations relate. Illustrative embodiments recognize that compliance obligation software systems can be incorporated into a risk assessment software to evaluate operational risk exposed to an entity based on the extent of the compliance obligations as well as a set of recommendations it needs to follow in order to reduce such operational risk. Further, illustrative embodiments recognize that these software systems may identify and assign action items to a compliance obligation. For example, Federal Deposit Insurance Corporation (FDIC) provides Dodd-Frank regulations that require a compliance obligation of conducting annual stress tests for financial institutions having assets above a certain value. A compliance obligation software system identifies a set of action items, such as gathering baseline stress test scenarios and reporting to FDIC, and assigns the set of action items to the compliance obligation resulting from the Dodd-Frank regulations. In this manner, an entity may streamline the process of staying current with its compliance obligations and can be confident that it will avoid adverse regulatory actions.

Illustrative embodiments further recognize that, as new regulations and other compliance obligations are increasingly being added to different industries, existing regulations and obligations are continuously updated at a similar rate. Illustrative embodiments recognize that several organizations have attempted to keep track of such updates. Existing solutions include comparing changes from an original document to the revised document. Illustrative embodiments recognize that changes to a document can be indicated by various means, including displaying the changes to the original document with redlines. After such processing, it can be manually determined by users whether the updates to the documents are significant enough that the affected entity needs to be notified.

Illustrative embodiments recognize that the extent of changes or updates to documents may differ. In addition, illustrative embodiments recognize that a first set of updates to a document may be more substantive compared to the second set of updates to the same document. For example, a first update to a document may only pertain to fixing typographical errors, but a second update to the document may impose a significant obligation to an entity. Illustrative embodiments also recognize that substantive updates to a document may not always depend on the number of changes made to the document. In another example, a document with an update that changed few words may be regarded as more significant than a second update which added a large number of words. Illustrative embodiments recognize that updates to a document may generate a set of actions that is required to be performed by an entity. For example, an update to a compliance obligation may trigger a system to notify the entity that it needs to re-certify that it remains in compliance with the compliance obligation after the update.

Illustrative embodiments recognize that software systems are typically utilized to enable monitoring sets of obligations an entity should perform in order to be in compliance with the regulations. As the regulations are updated, however, the current systems are unable to determine automatically whether such updates require the entities to continue or change their existing procedures to ensure ongoing compliance with such regulations. In addition, illustrative embodiments recognize that the current systems are unable to detect a set of obligations that previous does not require a first action by an entity but now does require such first action, in order to be in compliance with the updated regulations. Illustrative embodiments thus recognize that there is a significant technical challenge to efficiently determines whether an update to a document should trigger an alert for additional monitoring.

The illustrative embodiments recognize that the presently available tools or solutions do not address the needs or provide adequate solutions for these needs. The illustrative embodiments used to describe the invention generally address and solve the above-described problems and other problems related to monitoring updates to a document and determining the extent and impact of the updates based on the contextual data associated with such document.

An embodiment can be implemented as a software application. The application implementing an embodiment can be configured as a modification of an existing software platform, as a separate application that operates in conjunction with an existing software platform, a standalone application, or some combinations thereof.

In one embodiment of the present invention, the system automatically identifies which updates to a document (e.g. a regulation) are more relevant to a given entity, and whether the updates are significant enough to require further action from such entity. In some embodiments, these actions may include the entity to re-certify to its compliance of the obligation that was affected with the identified update.

In one embodiment, updates to an existing document are detected. Sources of the updates may include the same document source from which the existing document was originated. In some embodiments, the sources can be from a different source from which the existing document was originated. In some embodiments, the sources providing the updates could be linked with a script that triggers when the updates to the existing document occur. The script may be executed to extract the document from the linked source once the script is triggered. In one embodiment, the updates to an existing document are detected by comparing the time stamps assigned to the existing document and the new document.

In one embodiment, the system identifies which sections of the document were updated and determines a relevance score for the updated sections. In some embodiments, a first section of the document may be assigned with a lower relevance score than a second section. For example, an update to title and footnote sections may be assigned with a lower relevance score when compares to an update to the body section. In some embodiments, sections of the document are determined by parsing the metadata associated with the document. Parsing the metadata may include identifying at least one tag associated with a stream of text within the document (e.g., <body>), and set the tag as a first section of the document.

In one embodiment, the system computes the relevance score through a plurality of contextual factors. In several embodiments, the contextual factors may include temporal delay from the introduction of the update in the document source to the completion of the updates to the document, number of comments generated in response to the update, and number of times the update was revised before the update became complete. In other embodiments, the contextual factors may include the types of words used in the updates, including grammar, frequency of the terms appearing throughout the document, and definitions of the words that were added into the updates.

In one embodiment, the system determines a threshold value for the relevance score. Once the computed relevance score exceeds a threshold, embodiments of the present invention issues a notification to the system administrator that the updates to the document may require additional attention. In some embodiments, the system determines that a significantly high relevance score should trigger a second notification that the update causing the high relevance score should be prioritized for review. In another embodiment, the system may recommend that the system administrator revoke the existing certification by the entity that is in compliance with a set of obligations associated with the document.

The illustrative embodiments are described with respect to certain types of data updates, contextual factors, metadata, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

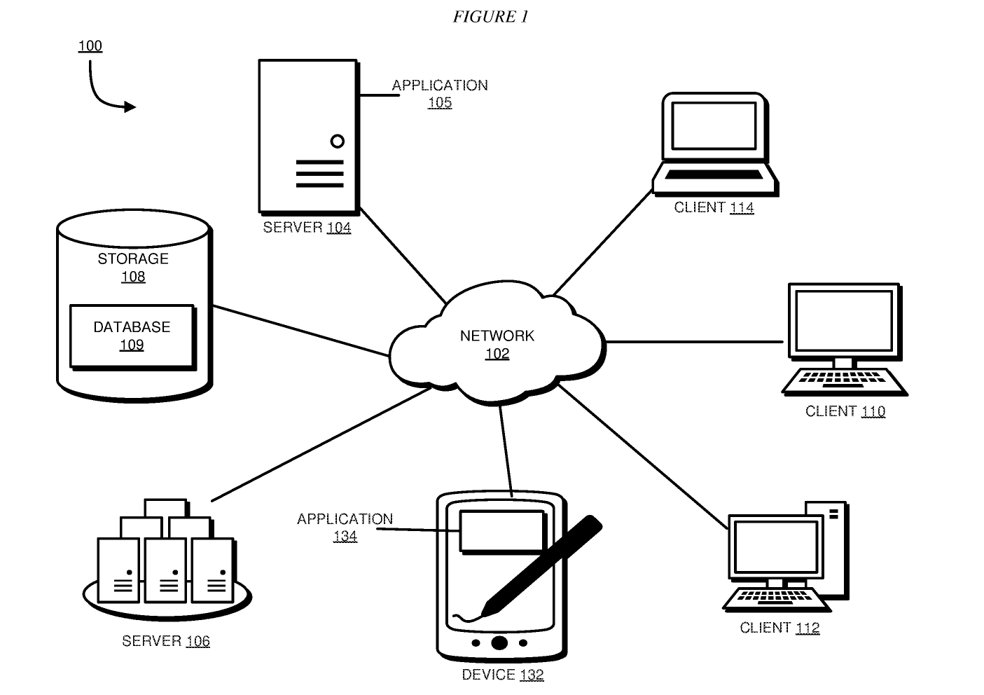

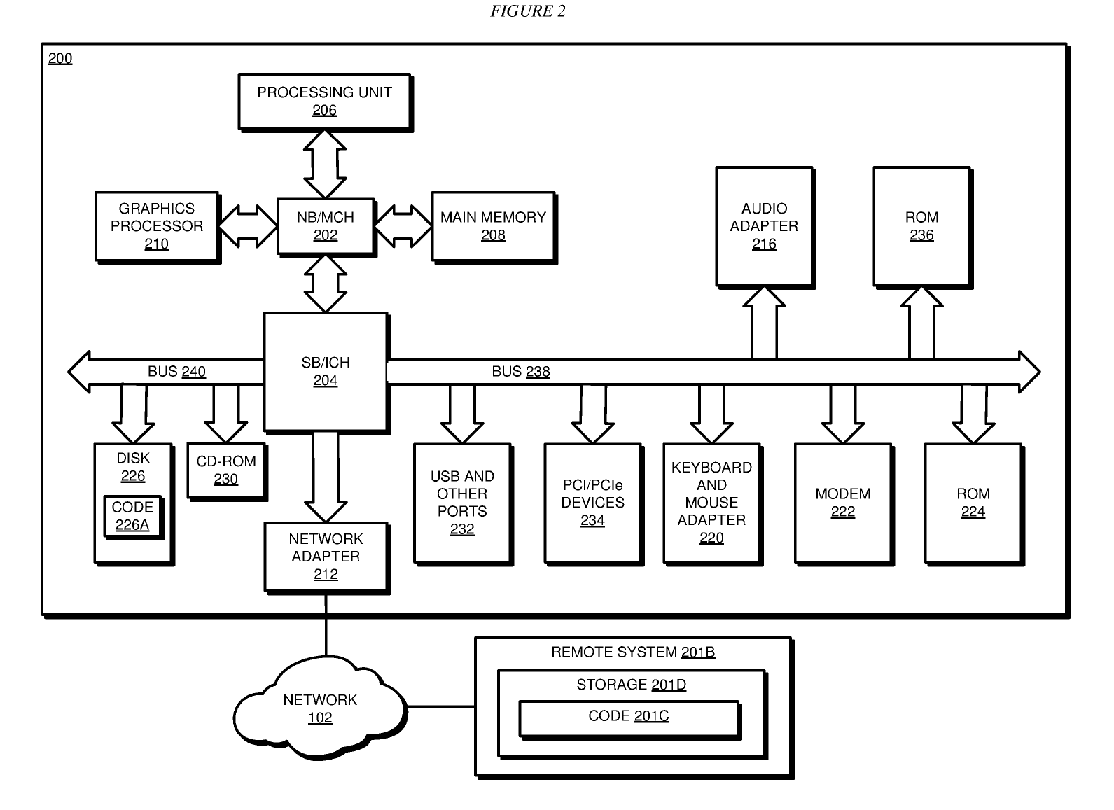

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 alone, application 134 alone, or applications 105 and 134 in combination implement an embodiment described herein. Channel data source 107 provides the past period data of the target channel or other channels in a manner described herein.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 and/or application 134 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

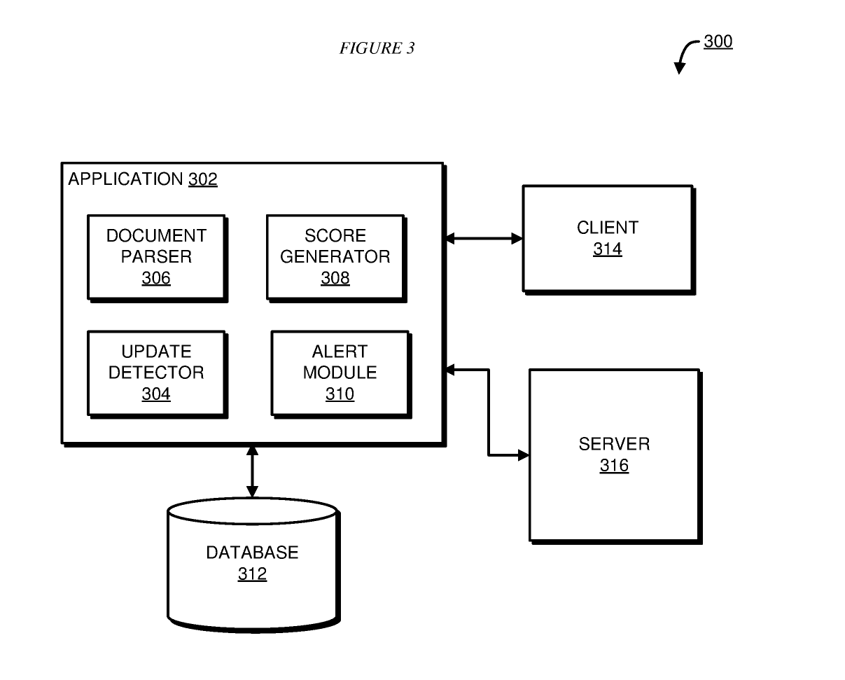

With reference to FIG. 3, this figure depicts a block diagram of an example system for monitoring updates to a document based on contextual data in accordance with an illustrative embodiment in accordance with an illustrative embodiment. Application 302 is an example of application 105 in FIG. 1. Client 314 are examples of clients 110, 112, and 114 in FIG. 1. Server 316 is an example of servers 104 and 106 in FIG. 1.

Application 302 includes update detector 304, document parser 306, score generator 308, and alert module 310. Update detector 304 may detect changes that are made to an existing document (e.g. compliance obligation, regulation) in database 312. In one embodiment, update detector 304 may detect that the existing document file is being updated by a user including making direct edits to the file. In other embodiments, update detector 304 may receive a different version of the existing document. In one embodiment, the different version of the document may be generated internally. In some embodiments, update detector 304 may retrieve the different version of the document from document sources from which the document originated. In some embodiments, application 302 may subscribe to a plurality of data sources which originally generated the documents in database 312. As the data sources provide updates to the documents, update detector 304 may receive notifications from the data sources that the updated versions of the document are available at which update detector 304 may automatically download the updated version from the data sources.

In several embodiments, update detector 304 may identify contextual data surrounding the content updates to the document existing in database 312. In some embodiments, the contextual data may include temporal delay value from the first availability of the content update in the document source to the completion of the content updates to the document. For example, update detector 304 identifies the “created_date” in the metadata embedded in the updated document or determines the date the updated document was published. In another example, update detector 304 detects that a content update includes the title “Introduction” and captures the upload date of such update. Thereafter, update detector 304 identifies whether a later version of the content update exists, and, if identified, calculates the duration of time between the date when the initial version of the update was generated and the date when the later version of the update was generated.

In another embodiment, update detector 304 counts the number of comments generated in response to the content updates. In this embodiment, update detector 304 identifies the URL in which the updates to the document became available and parses the HTML page associated with the URL. Based on the parsing, update detector 304 may detect that comments are present in the HTML page and tally the total number of comments uploaded to such URL. Update detector 304 stores the total number of comments and associates such value with the detected updates to the document. In yet another embodiment, update detector 304 determines the number of versions published between the existing document and the latest update to the document and stores the determined value with the detected updates to the document for further processing by score generator 308.

Document parser 306 analyzes the updated version of the document by comparing the updated version with the existing document and identifies parts of the document that were updated. In some embodiments, document parser 306 determines the amount and syntax of the updates. For example, document parser 306 may determine that the updates to the document may include 40 additional words which are characterized in 5 different sentence structures. In one embodiment, document parser 306 may assign definitions of the words and grammar tag on each of the tokens in the updated parts of the document which can be used for further processing by score generator 308. In some embodiments, document parser 306 may identify the coordinate position of the document in which the updates were made and associate such identified coordinate positions to the updates to the document for further processing by score generator 308. For example, document parser 306 identifies that the first set updates to the document was mostly focused on the lower left corner of the document and that the second set of updates to the document was on the center portion of the document. In both scenarios, document parser 306 may generate a set of values indicative of these positions and associate the set of values with the updates to the document for further processing by score generator 308.

In another embodiment, document parser 306 may detect the font size and format of the updates to the document. For example, document parser 306 may detect that the updates to the document included font that is in bold format and relatively larger than the font of the existing document. In such cases, it is likely that the update is directed towards a section title which corresponding values can be generated and associated with the updates to the document for further processing by score generator 308.

In some embodiments, document parser 306 may perform natural language processing (NLP) on the identified updates to the document. In this embodiment, document parser 306 may parse the text corpus of the updated parts and may output various analysis formats, including part-of-speech tagged text, phrase structure trees, and grammatical relations (typed dependency) format. In some embodiments, NLP algorithm can be trained through machine learning via a collection of syntactically annotated data such as the Penn Treebank. In one embodiment, document parser 306 may utilize lexicalized parsing to tokenize data records then construct a syntax tree structure of text tokens for each of data record. In another embodiment, document parser 306 may utilize dependency parsing to identifying grammatical relationships between each of the text tokens in each of the data records. In some embodiments, document parser 306 may recognize that the existing document has been processed by NLP algorithms. In such cases, document parser 306 may supplement the NLP output of the original document with the NLP output of the updated parts of the document.

Score generator 308 may determine a relevance score based on the output from update detector 304 and document parser 306. In several embodiments, relevance scores may allow application 302 to determine that the content updates are significant enough that additional action may be required by an entity. In one embodiment, score generator 308 may receive contextual data from update detector 304. The contextual data may include temporal delay value from the first availability of the update in the document source to the completion of the updates to the document, as described above. In some embodiments, the contextual data may be normalized into other values when computing the relevance score. For example, assume that the temporal delay value provided by update detector 304 is 60 days. In some embodiments, score generator 308 may use the same value (e.g., 60) to generate the relevance score or may normalize the value into another relevance score value such as converting 30 into 3. In this example, the normalization factor may be predetermined. In some embodiments, the contextual data may also include the number of comments generated in relation to the content updates. In another embodiment, the contextual data may include the number of versions published between the existing document and the latest content update. Similar to the temporal delay example, the above described contextual data can be normalized and converted into another value so as to generate the relevance score.

In some embodiments, score generator 308 may receive additional contextual data from document parser 306 to calculate the relevance score. In one embodiment, contextual data generated from document parser 306 may include definitions of the words added during the content updates. For example, the word “shall” may be assigned with a first relevance score, and likely a higher score than the word “may.” In another example, the word “confidential” may be assigned with a very high relevance score compared to other words such as “public.” In some embodiments, score generator 308 converts grammar tags into relevance score values. For example, a grammar tag with “verb” will have a higher value than the tag with “preposition.” In addition, a more compound grammar tag such as “predicate” will have a higher value than a simple grammar tag such as “noun.”

In some embodiments, additional contextual data received from document parser 306 may include the coordinate position, size, and format of the updates to the document. For instance, contextual data may indicate that substantial parts of the content update occurred at the footer region of the document outside the margins. In this case, score generator 308 computes a low relevance score as compared to a relevance score computed based on the coordinate position of the update being at the middle section of the document. In another example, the size of the font may affect the relevance score, including smaller fonts receiving a lower relevance score as opposed to normal font size. In several embodiments, score generator 308 aggregates the values generated from the contextual data received from update detector 304 and document parser 306 and generates the final relevance score to be used by alert module 310 for further processing.

Alert module 310 receives the relevance score generated from score generator 308 and determines whether an alert should be issued to client 314 and/or server 316. In one embodiment, alert module 310 compares the relevance score against a threshold value. In response to the relevance score exceeding the threshold value, alert module 310 issues the alert to client 314 and/or server 316. In some embodiments, alert module 310 may issue further actions that are required to be performed in response to the relevance score exceeding the threshold. The further actions may include revoking any compliance certification previously generated based on the existing document and preventing access to certain systems or databases at least until the content updates are reviewed by system administrator.

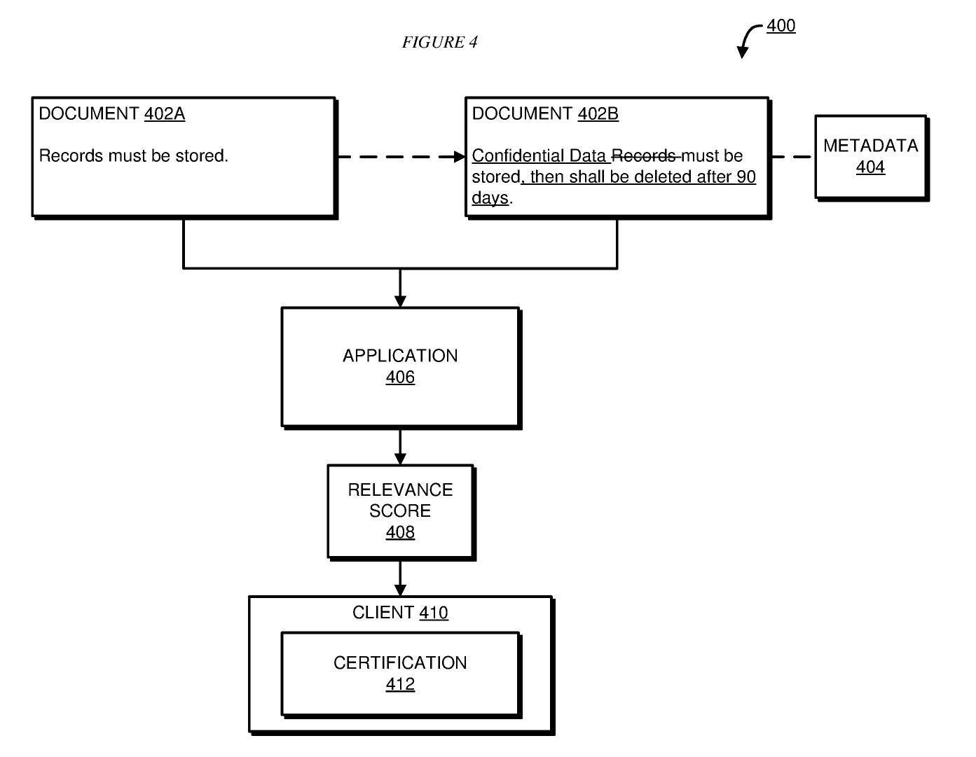

With reference to FIG. 4, this figure depicts a block diagram of an example implementation of monitoring updates to a document based on contextual data in accordance with an illustrative embodiment. Application 406 is an example of application 105 in FIG. 1 and application 302 in FIG. 3.

In this example implementation, document 402A may be an existing document stored in a database (e.g., database in FIG. 3) which includes a body of text “Records must be stored.” In this example implementation, a data source (not shown) provides document 402B including an updated text to document which provides “Confidential Data must be stored, then shall be deleted after 90 days.” Application 406 detects the update based on changes from document 402A to document 402B and extracts contextual data from the content updates via update detector 304 and document parser 306, as both set forth in FIG. 3. In one embodiment, application 406 utilizes metadata 404 from document 402B to extract contextual data yet further.

Application 406 then computes relevance score 408 for document based on the extracted contextual data. Application 406 determines whether an alert needs to be issued to client based on relevance score 408 exceeding a threshold value. Based on such determination, client 410 may take additional actions including deleting certification 412, which is a certification file based on compliance of process established based on document 402A. In other embodiments, client 410 may alert the user that relevance score 408 of document 402B exceeds the threshold value, at which time user may confirm or reject the alert. Depending on user feedback, application 406 may recalibrate the normalization factors for contextual data to improve accuracy when computing relevance scores for future content updates.

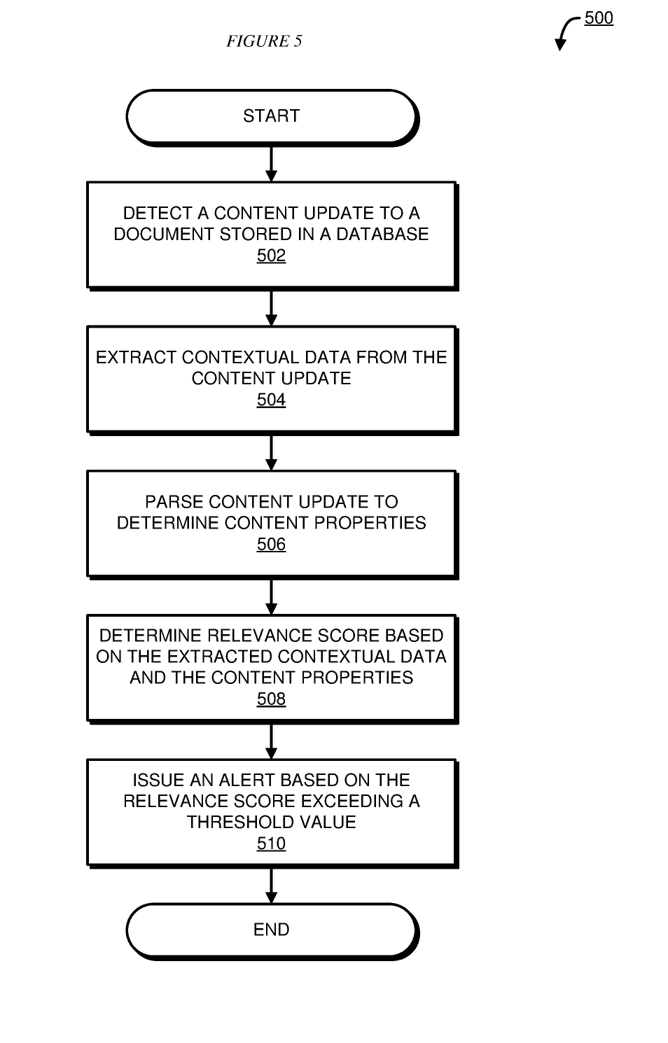

With reference to FIG. 5, this figure depicts a flowchart of an example process for monitoring updates to a document based on contextual data in accordance with an illustrative embodiment. Process 500 may be implemented in application 302 in FIG. 3.

The application detects a content update to an existing document in a database (block 502). The application extracts contextual data from the content update (block 504). In several embodiments, the contextual data includes temporal delay between the upload time of the first version of the content update and upload time of the latest version of the content update. The application parses content update to determine content properties (block 506). In several embodiments, the content properties may include coordinate position of the update, and the font size and format of the content update. The application determines relevance score based on the extracted contextual data and the content properties of the content update (block 508).

The application the issues an alert based on the relevance score exceeding a threshold value (block 510). In some embodiment, the application may execute additional actions based on the relevance score exceeding the same or different threshold value, which may include revoking certificate indicative of compliance to the procedures as set forth by the existing document. Process 500 terminates thereafter.

Thus, a computer implemented method, system or apparatus, and computer program product are provided in the illustrative embodiments for merging two documents that may contain different perspectives and/or bias. Where an embodiment or a portion thereof is described with respect to a type of device, the computer implemented method, system or apparatus, the computer program product, or a portion thereof, are adapted or configured for use with a suitable and comparable manifestation of that type of device.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of monitoring content updates to a document based on contextual data, the method comprising:
detecting a content update within an existing document stored in a database;
extracting contextual data from the content update, the contextual data including temporal delay between upload time of a first version of the content update and upload time of a last version of the content update;
computing relevance score of the content update based on the contextual data; and
issuing an alert in response to determining that the relevance score of the content update exceeds a first threshold value.

2. The method according to claim 1, further comprising:
revoking certificate indicative of compliance with the existing document in response to determining that the relevance score of the content update exceeds a second threshold value.

3. The method according to claim 2, further comprising:
denying access to the database in response to determining the relevance score of the content update exceeds a third threshold value.

4. The method according to claim 1, further comprising:
determining coordinate positions of the content update within the existing document;
converting the coordinate positions of the content update into a content properties value additionally indicative of the extracted contextual data; and
adjusting the relevance score based on the content properties value.

5. The method according to claim 4, further comprising:
identifying font size and format of the content update within the existing document; and
adjusting the content properties value based on identified font size and format of the content update.

6. The method according to claim 1, wherein the contextual data further includes number of comments published with the content update and number of content update versions uploaded between the existing document and the content update.

7. The method according to claim 1, further comprising:
identifying metadata tag associated with the content update within the existing document, wherein the relevance score is adjusted based on the identified metadata tag.

8. A computer program product for monitoring content updates to a document based on contextual data, the computer program product comprising one or more computer readable storage medium and program instructions stored on at least one of the one or more computer readable storage medium, the program instructions comprising:
program instructions to detect a content update within an existing document stored in a database;
program instructions to extract contextual data from the content update, the contextual data including temporal delay between upload time of a first version of the content update and upload time of a last version of the content update;
program instructions to compute relevance score of the content update based on the contextual data; and
program instructions to issue an alert in response to determining that the relevance score of the content update exceeds a first threshold value.

9. The computer program product according to claim 8, further comprising:
program instructions to revoke certificate indicative of compliance with the existing document in response to determining that the relevance score of the content update exceeds a second threshold value.

10. The computer program product according to claim 9, further comprising:
program instructions to deny access to the database in response to determining the relevance score of the content update exceeds a third threshold value.

11. The computer program product according to claim 8, further comprising:
program instructions to determine coordinate positions of the content update within the existing document;
program instructions to convert the coordinate positions of the content update into a content properties value additionally indicative of the extracted contextual data; and
program instructions to adjust the relevance score based on the content properties value.

12. The computer program product according to claim 11, further comprising:
program instructions to identify font size and format of the content update within the existing document; and
program instructions to adjust the content properties value based on identified font size and format of the content update.

13. The computer program product according to claim 8, wherein the contextual data further includes number of comments published with the content update and number of content update versions uploaded between the existing document and the content update.

14. The computer program product according to claim 8, further comprising:
program instructions to identify metadata tag associated with the content update within the existing document, wherein the relevance score is adjusted based on the identified metadata tag.

15. A computer system for monitoring content updates to a document based on contextual data, the computer system comprising one or more processors, one or more computer readable memories, one or more computer readable storage medium, and program instructions stored on at least one of the one or more storage medium for execution by at least one of the one or more processors via at least one of the one or more memories, the program instructions comprising:
program instructions to detect a content update within an existing document stored in a database;
program instructions to extract contextual data from the content update, the contextual data including temporal delay between upload time of a first version of the content update and upload time of a last version of the content update;
program instructions to compute relevance score of the content update based on the contextual data; and
program instructions to issue an alert in response to determining that the relevance score of the content update exceeds a first threshold value.

16. The computer system according to claim 15, further comprising:
program instructions to revoke certificate indicative of compliance with the existing document in response to determining that the relevance score of the content update exceeds a second threshold value.

17. The computer system according to claim 16, further comprising:
program instructions to deny access to the database in response to determining the relevance score of the content update exceeds a third threshold value.

18. The computer system according to claim 15, further comprising:
program instructions to determine coordinate positions of the content update within the existing document;
program instructions to convert the coordinate positions of the content update into a content properties value additionally indicative of the extracted contextual data; and
program instructions to adjust the relevance score based on the content properties value.

19. The computer system according to claim 18, further comprising:
program instructions to identify font size and format of the content update within the existing document; and
program instructions to adjust the content properties value based on identified font size and format of the content update.

20. The computer system according to claim 15, wherein the contextual data further includes number of comments published with the content update and number of content update versions uploaded between the existing document and the content update.
